(19) United States
(12) Patent Application Publication
(10) Pub. No.: US 2016/0358675 A1
(43) Pub. Date: Dec. 8, 2016

(54) NUCLEAR CORE COMPONENT HOLD-DOWN ASSEMBLY AND NUCLEAR REACTOR FUEL ASSEMBLY

(71) Applicant: China Nuclear Power Technology Research Institute Co., Ltd., Shenzhen (CN)

(72) Inventors: Wenchi Yu, Shenzhen (CN); Xiaoming Chen, Shenzhen (CN); Xianfeng Lv, Shenzhen (CN); Weicai Li, Shenzhen (CN); Yuemin Zhou, Shenzhen (CN); Yahong Hu, Shenzhen (CN); Shilei Li, Shenzhen (CN)

(21) Appl. No.: 14/550,900

(22) Filed: Nov. 21, 2014

(30) Foreign Application Priority Data
Mar. 17, 2014 (CN) 201410099307.1

(51) Int. Cl. G21C 3/33; G21C 3/322

(52) U.S. Cl. CPC G21C 3/331; G21C 3/322; G21Y 2002/30; G21Y 2004/30

(57) ABSTRACT

A nuclear core component hold-down assembly includes a hollow spring guide in which an instrumentation insertion channel is formed; a base plate which has a center hole formed through a center thereof, and several water flow holes formed around the center hole; a lower end of the spring guide connecting and mating with an upper end of the base plate, the instrumentation insertion channel communicating with the center hole, and the base plate locating above the adapter plate and pressing against it directly; a hold-down bar slidably mounted on an upper end of the spring guide and locating above the base plate; and a spring element configured between the hold-down bar and the base plate, by which the hold-down bar pushes the base plate to cause the base plate to press against the adapter plate. The structure is stable and reliable.

### RELATED APPLICATIONS

This application claims the benefit of priority to Chinese Patent Application No. 201410099307.1, filed on Mar. 17, 2014, which is hereby incorporated by reference in its entirety.

### FIELD OF THE INVENTION

The present invention relates to a hold-down assembly in nuclear reactions and, more particularly to a nuclear core component hold-down assembly for pressing the adapter plate of the top nozzle of nuclear reactors.

### BACKGROUND OF THE INVENTION

Chinese patent publication No. 101587755A (with title of “Nuclear core component hold-down assembly, Application No. 200910138856.4”) discloses detailed structure and working principle of the nuclear core component hold-down assembly. Concretely, the base plate of the nuclear core component hold-down assembly has some small holes formed for suspending rods, such as thimble plug rods, primary neutron source rods, secondary neutron source rods, or burnable poison rods. Additionally, the base plate further opens some water flow holes for improving the flowage of the coolant. Before the nuclear reactor works, the nuclear core component hold-down assembly will be mounted in the top nozzle of the fuel assembly, and rods suspended in the nuclear core component hold-down assembly will be inserted into the guide tubes of the fuel assembly. During operation of the nuclear reactor, the coolant flows from down to up in the guide tubes, so that the rods suspended in the guide tubes will be suffered with buoyancy and lifting force. For keeping the rods in the fixed position, it's necessary to use the nuclear core component hold-down assembly. Concretely, the hold-down bar transfers the stress from the upper nuclear reactor core plate to the spring, and then the stress is transferred to the base plate through the spring, thereby the rods may not be lifted when suffering the buoyancy of the coolant and the lifting force of the guide tubes.

For better explaining the nuclear core hold-down assembly of the present invention, now detailed explanation of the conventional nuclear core hold-down assembly follows. As shown in FIGS. 1 and 2, the conventional nuclear core hold-down assembly 100′ disclosed in the Chinese Patent No. 101587755A includes a spring guide 10′, a base plate 20′, a hold-down bar 30′ and springs 40′. Size of the base plate 20′ is configured to position in the top nozzle (also called upper base) of the nuclear fuel assembly and above the adapter plate 50′ top nozzle and the base plate 20′ is separated from the adapter plate 50′. Multiple openings (namely through holes) are formed on the base plate 20′, which are aligned with the equivalent holes on the adapter plate 50′, so as to connect with a control rod guides in the fuel assembly. Concretely, the spring guide 10′ is hollow, vertical and elongated. The hollow formed an instrumentation insertion channel 11′, in which in-core detector instrumentation 12′ is inserted to detect the status of the reactor core accurately and timely. The spring guide 10′ has an axis along the elongated dimension and extending through and below the center hole 21′ in the base plate 20′ to mate with the upper opening in an instrument thimble in the fuel assembly, as a result, the spring guide 10′ may contact with the adapter plate 50′ directly by its lower end passing through the center hole 21′ and protruding from the base plate 20′. More specifically, the spring guide 10′ is fixed on the base plate 20′ by welding, and multiple water flow holes 22′ are formed on the base plate 20′ and arranged around the center hole 21′ for allowing the coolant to flow through. The spring guide 10′ is extended vertically above the base plate 20′ and sized to extend through the upper core plate when installed in the core of the reactor. Additionally, the base plate 20′ is provided with multiple small holes 26′ for suspending rods, such as thimble plug rods, primary neutron source rods, secondary neutron source rods, or burnable poison rods. The hold-down bar 30′ is slidably mounted on the spring guide and having an axial travel length that is restrained a given distance below the top of the spring guide 10′ so that the spring guide 10′ extends above the hold-down bar 30′ when the hold-down bar 30′ is fully extended in a direction away from the base plate 20′. The spring 40′ is concentrically mounted and fixed around the spring guide 10′ and extended between the hold-down bar 30′ and the base plate 20′. By this token, the principle of the nuclear core component hold-down assembly holding down the adapter plate 50′ of the top nozzle is that, when suffering a stress applied by the upper core plate, the hold-down bar 30′ will move downwards along the spring guide 10′ due to it is slidably mounted on the upper end of the spring guide 10′, so that the stress will be transferred to the base plate 20′ via the springs 40′, accordingly, the downward stress will be transferred to the spring guide 10′ due to the base plate 20′ is welded with the spring guide 10′. Because the lower end of the spring guide 10′ passes through the center hole 21′ and directly contacts the adapter plate 50′, the spring guide 10′ has the downward stress to hold down the adapter plate 50′, thereby holding down the nuclear core component. By this token, the stress transfer during the hold-down process of the conventional nuclear core component hold-down assembly 100′ is like this, hold-down bar 30′→spring 40′→base plate 20′→spring guide 10′→adapter plate 50′. However, such a nuclear core component hold-down assembly 100′ has the following drawbacks to cause the stability and reliability weak, as described:

(1) Due to the lower end of the spring guide 10′ is welded with the base plate 20′, and the stress is transferred via the base plate 20′, therefore when suffering the downward stress from the spring 40′, the base plate 20′ will transfer it to the spring guide 10′. Based on the RCC-M standard (with full name of Mechanical equipment design and construction rules for pressurized water reactor nuclear power plant), after welding, the stress of the welding seam and the material around will be decreased by one fourth. By this token, strength of the welding position between the base plate 20′ and the spring guide 10′ is reduced seriously, and moreover this welding position is the stress transferring position from the base plate 20′ to the spring guide 10′, therefore this welding position becomes weak, which affects the stability and the reliability of the nuclear core component hold-down assembly 100′, and causes it not be applicable to the nuclear reaction assembly accordingly.

(21) Due to the lower end of the spring guide 10′ is directly contacted with the adapter plate 50′ to hold it down, and furthermore the spring guide 10′ is hollow, vertical and elongated, thus the contacting area between the lower end of the spring guide 10′ and the adapter plate 50′ is small, which causes larger stress is applied to the adapter plate 50′ and the bottom of the spring guide 10′ when the weights of the nuclear core component and upper core plate hold-down force are transferred to the adapter plate 50′, this will causes damage easily on spring guide 10′ and adapter plate 50′, thereby the stability and the reliability of the nuclear core component hold-down assembly 100′ is reduced, which causes it not be applicable to the nuclear reaction assembly accordingly.

(3) The stress transfer (hold-down bar→spring→base plate→spring guide→adapter plate) during the hold-down process of the conventional nuclear core component hold-down assembly 100′ is complex. Due to the lower end of the spring guide 10′ is extended through and welded with the base plate 20′ and the base plate 20′ is a horizontal plate, furthermore the stress direction (namely the vertical direction) and the distributing direction of the welding seams are the same, additionally the allowable stress of the welding seams and the material around is decreased with one fourth after welding as explained above, therefore, the welding position between base plate 20′ and the spring guide 10′ is easy to be separated, to make hold-down force applied to the adapter plate 50′ is uneven or lost. In conclusion, the structure of the convention nuclear core component hold-down assembly 100′ is not safe, and the stress transfer during the hold-down process is not reliable.

In view of the reasons mentioned above, the inventors invent a new nuclear core component hold-down assembly with improved stability and stability after long-term research and practice, which has the new structure and different stress transfer process to overcome the above-mentioned drawbacks and obtain positive beneficial effects.

### SUMMARY OF THE INVENTION

One objective of the present invention is to provide a nuclear core component hold-down assembly with improved stability and reliability.

Another objective of the present invention is to provide a nuclear reactor fuel assembly including a component hold-down assembly with improved stability and reliability.

To achieve the above-mentioned objectives, a nuclear core component hold-down assembly, configured on an adapter plate of a top nozzle, the nuclear core component hold-down assembly includes:

a hollow spring guide in which an instrumentation insertion channel is formed;

a base plate which has a center hole formed through a center thereof, and several water flow holes formed around the center hole; a lower end of the spring guide connecting and mating with an upper end of the base plate, the instrumentation insertion channel communicating with the center hole, and the base plate locating above the adapter plate and pressing against it directly;

a hold-down bar slidably mounted on an upper end of the spring guide and locating above the base plate; and

a spring element configured between the hold-down bar and the base plate, by which the hold-down bar pushes the base plate to cause the base plate to press against the adapter plate.

Preferably, a lower end of the base plate is provided with a downward protrusion surrounding the center hole and extending towards the adapter plate, and the center hole is extended through the downward protrusion, by which the base plate is pressing against the adapter plate directly. Thereby the adapter plate is held down by the downward protrusion of the base plate, so that pressing force is transferred to the adapter plate via the base plate, which prevents the welding seams from enduring load, thereby further improving stability and reliability of the present invention.

Preferably, the lower end of the spring guide is inserted into the base plate so as to connect and mate with it. Thereby the connection between the spring guide and the base plate is more stable and firm.

Preferably, the lower end of the spring guide is inserted into the center hole of the base plate so as to connect and mate with it. Thereby the connection between the spring guide and the base plate is more stable and firm.

Preferably, a first expanding slot is extended in the center hole, and the lower end of the spring guide is inserted into the first expanding slot so as to connect and mate with the base plate.

Preferably, an insertion portion is protruded from the lower end of the spring guide and towards the base plate, the instrumentation insertion channel is extended through the insertion portion, and the insertion portion is inserted into the center hole of the base plate so as to connect and mate with it.

Preferably, the center hole of the base plate is shaped as a frustum.

Preferably, a lower end of the base plate is provided with an upward protrusion surrounding the center hole and extending towards the spring guide, and the center hole is extended through the upward protrusion, by which the base plate connects and mates with the lower end of the spring guide.

Preferably, the upward protrusion is inserted into the spring guide so that the base plate is connected and mated with the spring guide.

Preferably, a second expanding slot is extended in the instrumentation insertion channel of the lower end of the spring guide, and the upward protrusion is inserted into the second expanding slot so as to connect and mate with it.

Preferably, the base plate has a frustum-shaped longitudinal section.

Preferably, multiple notches are depressed inwards on a lower end of the base plate, and multiple small holes are formed through the notches. Arrangement of the notches improves the flowage of the coolant in the nuclear reactor.

Preferably, the spring element is a helical spring which is positioned around the spring guide.

Preferably, edges of the base plate are chamfered.

Preferably, the instrumentation insertion channel includes at least one tapered channel with a wider upper portion and a narrow lower portion.

Preferably, the tapered channel has a tapered angle in a range of 1° to 45°.

Preferably, the instrumentation insertion channel includes at least one cylindrical channel.

A nuclear reactor fuel assembly, comprising a bottom nozzle, a top nozzle, spacer grids, guide tubes and fuel rods, the fuel rods and the guide tubes inserted into the spacer grids respectively, the guide tubes having upper ends connected and mating with the top nozzle and bottom nozzle connected and mating with the bottom nozzle, and the nuclear reactor fuel assembly further comprising a nuclear core component hold-down assembly as mentioned above, which is arranged for holding down an adapter plate of the top nozzle.

In comparison with the prior art, because the lower end of the spring guide of nuclear core component hold-down assembly of the present invention is connected with the adapter plate directly and pressed against the base plate located above, during working, the hold-down bar is applied with force to move downwards and pushes the base plate to contact and press against the adapter plate due to the spring element, so as to hold down the adapter plate. Based on the adapter plate is held down by the nuclear core component hold-down assembly by means of the base plate, on one hand, the contacting area between the base plate and the adapter plate is increased, so that the stress endured by the base plate and the adapter plate becomes smaller and more even, which prevents the base plate and the adapter plate from being damaged; on the other hand, stress transfer among the components is like this, hold-down bar→spring element→base plate→adapter plate, which is drastically different from the conventional one (namely the stress transfer—hold-down bar→spring→base plate→spring guide→adapter plate). The present invention keeps the stress transfer in the vertical direction, so that problems brought by the stress transfer in the transverse direction could be avoided, therefore the nuclear core component hold-down assembly of the present invention has simple structure with reasonable arrangements, and high stabilization and reliability, and breaks through the conventional stress transfer in the nuclear core component hold-down assembly to achieve the new concept and new technique.

### BRIEF DESCRIPTION OF THE DRAWINGS

The accompanying drawings facilitate an understanding of the various embodiments of this invention. In such drawings:

FIG. 1 is a perspective view of a conventional nuclear core component hold-down assembly;

FIG. 2 is a sectional view of FIG. 1;

FIG. 3 is a sectional view of a nuclear core component hold-down assembly according to a first embodiment of the present invention;

FIG. 4 is a sectional view of a nuclear core component hold-down assembly according to a second embodiment of the present invention;

FIG. 5 is a sectional view of a nuclear core component hold-down assembly according to a third embodiment of the present invention;

FIG. 6 is a sectional view of a nuclear core component hold-down assembly according to a fourth embodiment of the present invention;

FIG. 7 is a sectional view of a nuclear core component hold-down assembly according to a fifth embodiment of the present invention;

FIG. 8 is a sectional view of a nuclear core component hold-down assembly according to a sixth embodiment of the present invention;

FIG. 9 is a sectional view of a nuclear core component hold-down assembly according to a seventh embodiment of the present invention;

FIG. 10 is a sectional view of a nuclear core component hold-down assembly according to an eighth embodiment of the present invention;

FIG. 11 is a sectional view of a nuclear core component hold-down assembly according to a ninth embodiment of the present invention;

FIG. 12 is a perspective view of the base plate of the nuclear core component hold-down assembly accordingly to the present invention;

FIG. 13 in another perspective view of the base plate of FIG. 12.

FIG. 14 is a sectional view of the frustum-shape base plate and the adapter plate connected together;

FIG. 15 is another sectional view of the frustum-shape base plate;

FIG. 16a is a sectional view of the instrumentation insertion channel of the spring guide of the nuclear core component hold-down assembly according to a first embodiment of the present invention;

FIG. 16b is a sectional view of the instrumentation insertion channel of the spring guide of the nuclear core component hold-down assembly according to a second embodiment of the present invention;

FIG. 16c is a sectional view of the instrumentation insertion channel of the spring guide of the nuclear core component hold-down assembly according to a third embodiment of the present invention;

FIG. 16d is a sectional view of the instrumentation insertion channel of the spring guide of the nuclear core component hold-down assembly according to a fourth embodiment of the present invention;

FIG. 16e is a sectional view of the instrumentation insertion channel of the spring guide of the nuclear core component hold-down assembly according to a fifth embodiment of the present invention;

FIG. 16f is a sectional view of the instrumentation insertion channel of the spring guide of the nuclear core component hold-down assembly according to a sixth embodiment of the present invention; and

FIG. 17 is a side view of a nuclear core fuel assembly according to the present invention.

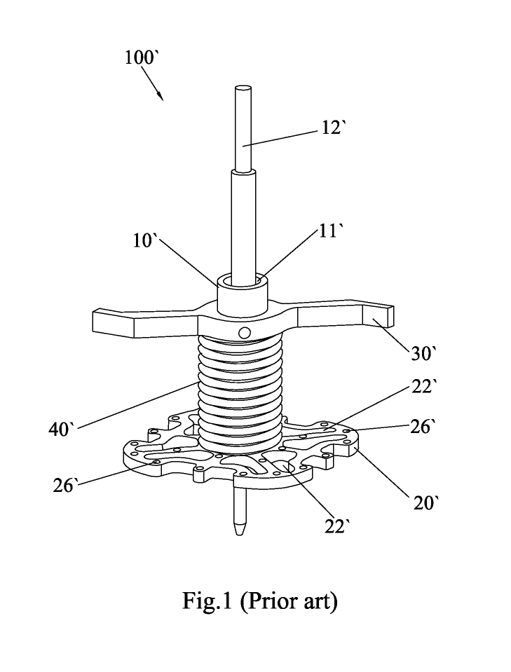

### DETAILED DESCRIPTION OF ILLUSTRATED EMBODIMENTS

Various preferred embodiments of the invention will now be described with reference to the figures, wherein like reference numerals designate similar parts throughout the various views.

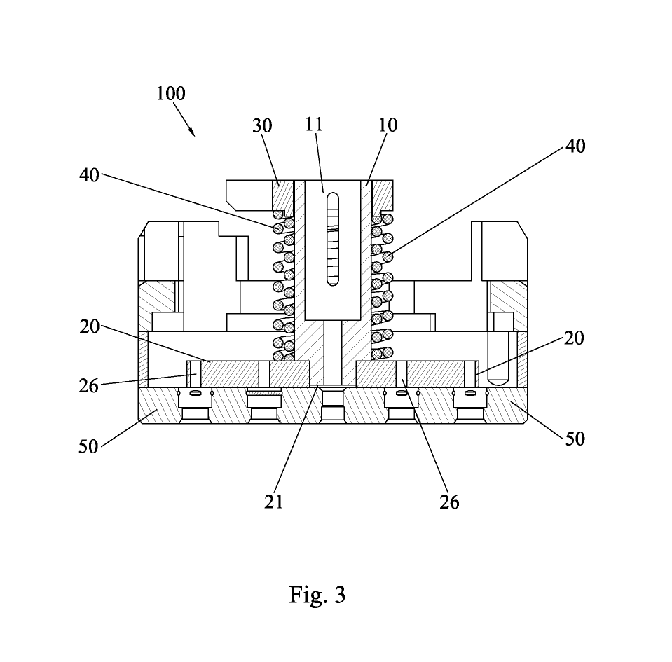

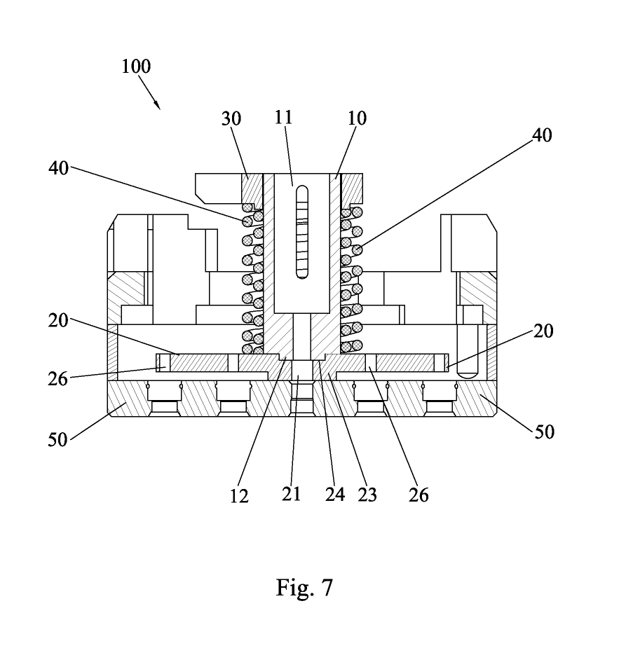

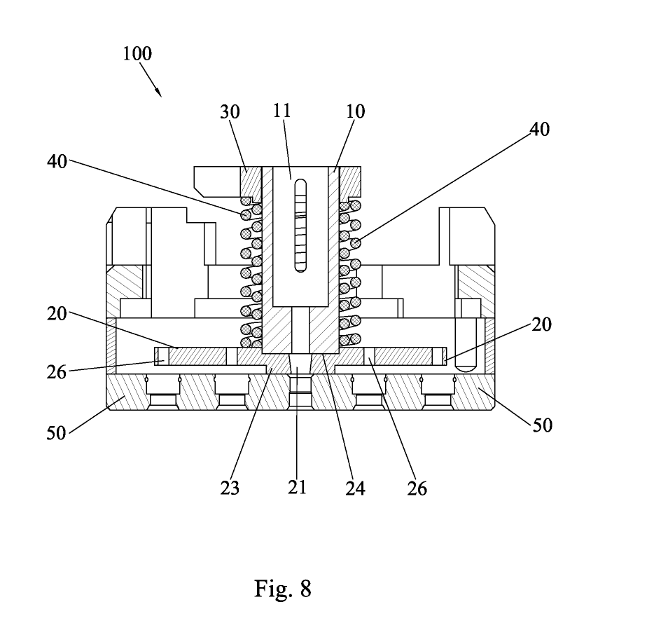

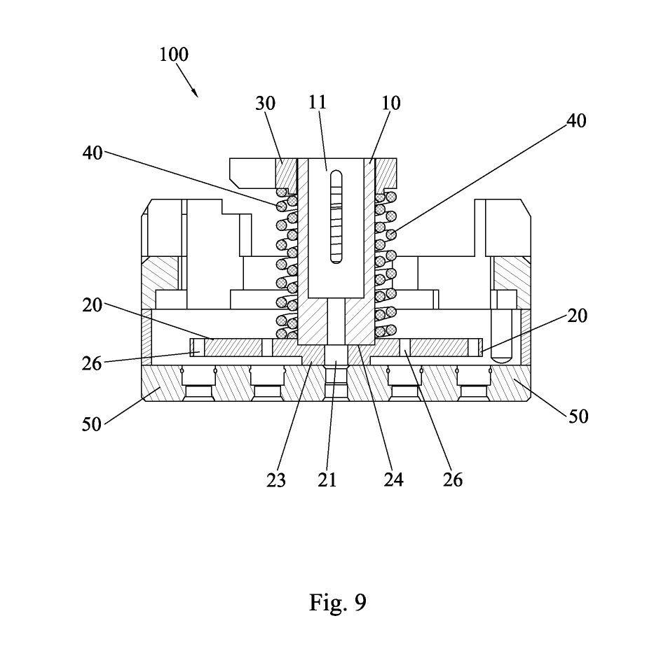

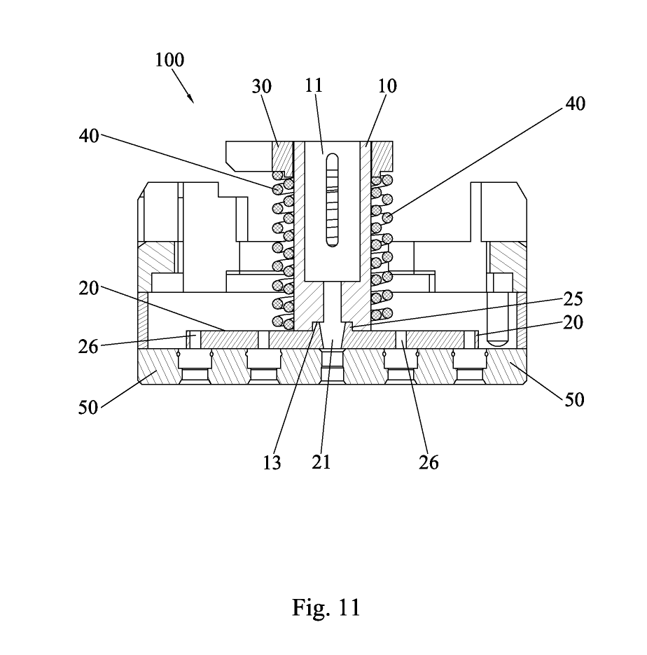

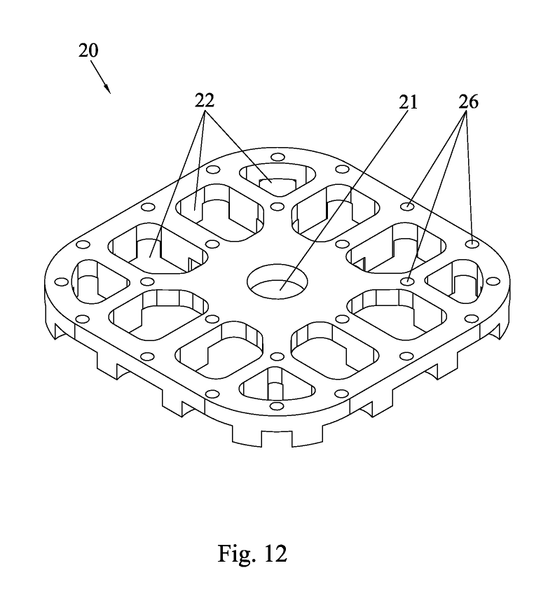

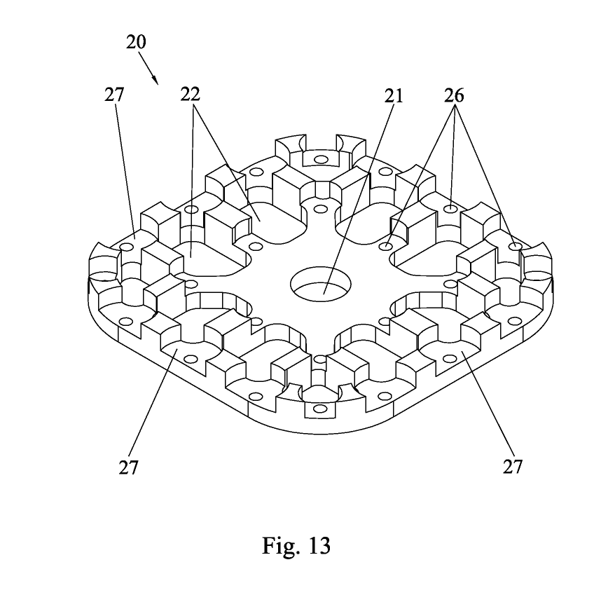

Referring to FIGS. 3-13, the nuclear core component hold-down assembly includes a spring guide 10, a base plate 20, a hold-down bar 30 and a spring element 40. The spring guide 10 is hollow, and an instrumentation insertion channel 11 is formed through the spring guide 10, by which an in-core detector instrumentation inserted may detect the status of the reaction core accurately and timely. The base plate 20 has a center hole 21 formed through a center thereof, and several water flow holes 22 (referring to FIGS. 12 and 13) formed around the center hole 21. The lower end of the spring guide 10 is connected and mated with the upper end of the base plate 20, and the instrumentation insertion channel 11 is communicated with the center hole 21. Specifically, the instrumentation insertion channel 11 and the center hole 21 are located at the same straight line, and the base plate 20 is located above the adapter plate 50 and pressed against it directly. The hold-down bar 30 is slidably mounted on the upper end of the spring guide 10 and located above the base plate 20, and the spring element 40 is configured between the hold-down bar 30 and the base plate 20, by which the hold-down bar 30 is pushing the base plate 20 to cause the base plate 20 to press against the adapter plate 50 directly. Detailed description of the nuclear core component hold-down assembly 100 of the present invention will be followed, by combination with FIGS. 3-13.

Combining FIGS. 3-9, 12 and 13, as a preferably embodiment, the nuclear core component hold-down assembly 100 of the present invention includes a spring guide 10, a base plate 20, a hold-down bar 30 and a spring element 40. The spring guide 10 is hollow, and an instrumentation insertion channel 11 is formed through the spring guide 10. The base plate 20 has a center hole 21 formed through a center thereof, and several water flow holes 22 formed around the center hole 21. The lower end of the spring guide 10 is connected and mated with the upper end of the base plate 20, concretely, the lower end of the spring guide 10 is inserted in to the base plate 20 so as to mate with it. The instrumentation insertion channel 11 is communicated with the center hole 21, and the base plate 20 is located above the adapter plate 50 and pressed against it directly. The hold-down bar 30 is slidably mounted on the upper end of the spring guide 10 and located above the base plate 20, and the spring element 40 is configured between the hold-down bar 30 and the base plate 20, by which the hold-down bar 30 is for pushing the base plate 20 to cause the base plate 20 to press against the adapter plate 50 directly. Such a connection way of inserting the lower end of the spring guide 10 into the base plate 20 ensures a stable and firm connection between the spring guide 10 and the base plate 20.

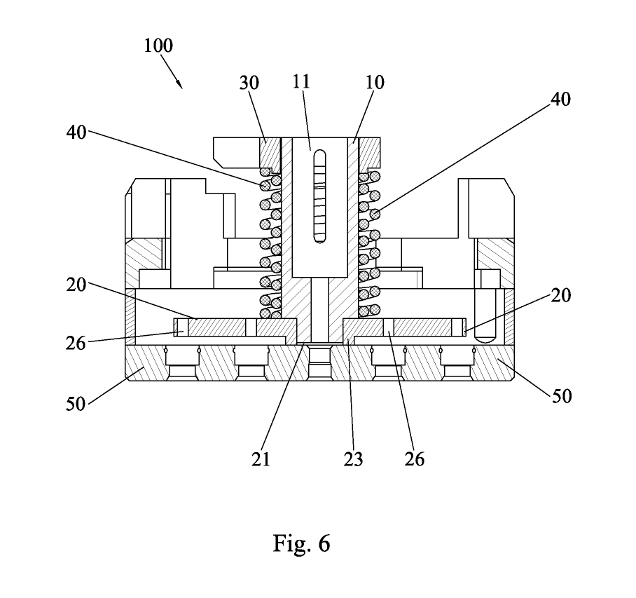

As another preferable embodiment, as shown in FIGS. 6-9, 12 and 13, the nuclear core component hold-down assembly 100 of the present invention includes a spring guide 10, a base plate 20, a hold-down bar 30 and a spring element 40. The spring guide 10 is hollow, and an instrumentation insertion channel 11 is formed through the spring guide 10. The base plate 20 has a center hole 21 formed through a center thereof, and several water flow holes 22 formed around the center hole 21. The lower end of the spring guide 10 is connected and mated with the upper end of the base plate 20. Concretely, the lower end of the base plate 20 is provided with a downward protrusion 23 surrounding the center hole 21 and extending towards the adapter plate 50, and the center hole 21 is extended through the downward protrusion 23, by which the base plate 20 is pressing against the adapter plate 50. The instrumentation insertion channel 11 is communicated with the center hole 21, and the base plate 20 is located above the adapter plate 50 and pressed against it directly. The hold-down bar 30 is slidably mounted around the upper end of the spring guide 10 and located above the base plate 20, and the spring element 40 is configured between the hold-down bar 30 and the base plate 20, by which the hold-down bar 30 moves downwards and pushes the downward protrusion 23 of the base plate 20 to contact and press against the adapter plate 50 directly. Thereby the adapter plate 50 is held down by the downward protrusion 23 of the base plate 20, so that pressing force is transferred to the adapter plate 50 via the base plate 20, which prevents the welding seams from enduring load, thereby further improving stability and reliability of the present invention.

As another preferable embodiment, as shown in FIGS. 3, 6, 12 and 13, the nuclear core component hold-down assembly 100 of the present invention includes a spring guide 10, a base plate 20, a hold-down bar 30 and a spring element 40. The spring guide 10 is hollow, and an instrumentation insertion channel 11 is formed through the spring guide 10. The base plate 20 has a center hole 21 formed through a center thereof, and several water flow holes 22 formed around the center hole 21. The lower end of the spring guide 10 is connected and mated with the upper end of the base plate 20, concretely, the lower end of the spring guide 10 is inserted into the center hole 21 of the base plate 20 so as to connect. The instrumentation insertion channel 11 is communicated with the center hole 21, and the base plate 20 is located above the adapter plate 50 and pressed against it directly. The hold-down bar 30 is slidably mounted on the upper end of the spring guide 10 and located above the base plate 20, and the spring element 40 is configured between the hold-down bar 30 and the base plate 20, by which the hold-down bar 300 moves downwards and pushes the base plate 20 to press against the adapter plate 50 directly. In such a way, the center hole 21 of the base plate 20 is provided to allow the lower end of the spring guide 10 to insert and connect, such a structure is simple and practical, which ensures the connection between the spring guide 10 and the base plate 20 more stable and firm.

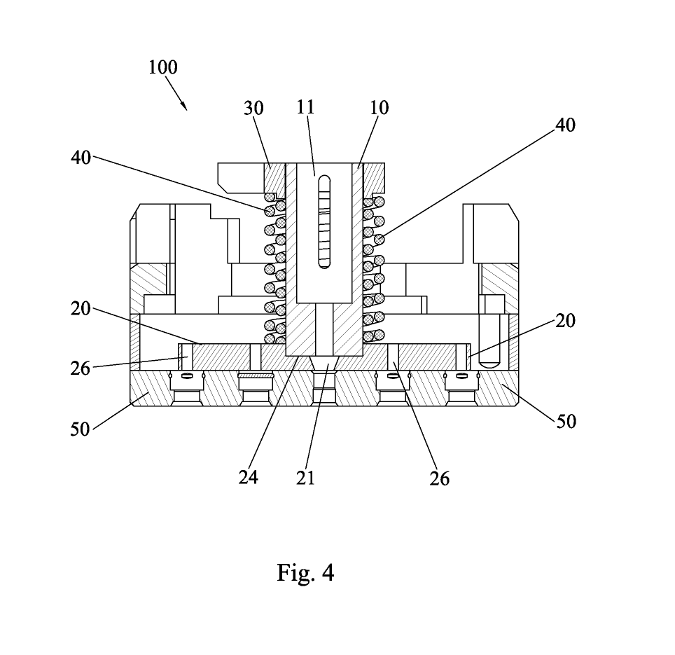

As another preferable embodiment, as shown in FIGS. 4-5, 7-9,12 and 13, the nuclear core component hold-down assembly 100 of the present invention includes a spring guide 10, a base plate 20, a hold-down bar 30 and a spring element 40. The spring guide 10 is hollow, and an instrumentation insertion channel 11 is formed through the spring guide 10. The base plate 20 has a center hole 21 formed through a center thereof, and several water flow holes 22 formed around the center hole 21. The lower end of the spring guide 10 is connected and mated with the upper end of the base plate 20. Concretely, a first expanding slot 24 is extended in the center hole 21, and the lower end of the spring guide 10 is inserted into the first expanding slot 24 so as to connect and mate with the base plate 20. The instrumentation insertion channel 11 is communicated with the center hole 21, and the base plate 20 is located above the adapter plate 50 and pressed against it directly. The hold-down bar 30 is slidably mounted on the upper end of the spring guide 10 and located above the base plate 20, and the spring element 40 is configured between the hold-down bar 30 and the base plate 20, by which the hold-down bar 300 moves downwards and pushes the base plate 20 to press against the adapter plate 50 directly. In such a way, the first expanding slot 24 formed in the center hole 21 of the base plate 20 is allowed to the lower end of the spring guide 10 to insert and connect, such a structure is simple and practical, which ensures the connection between the spring guide 10 and the base plate 20 more stable and firm.

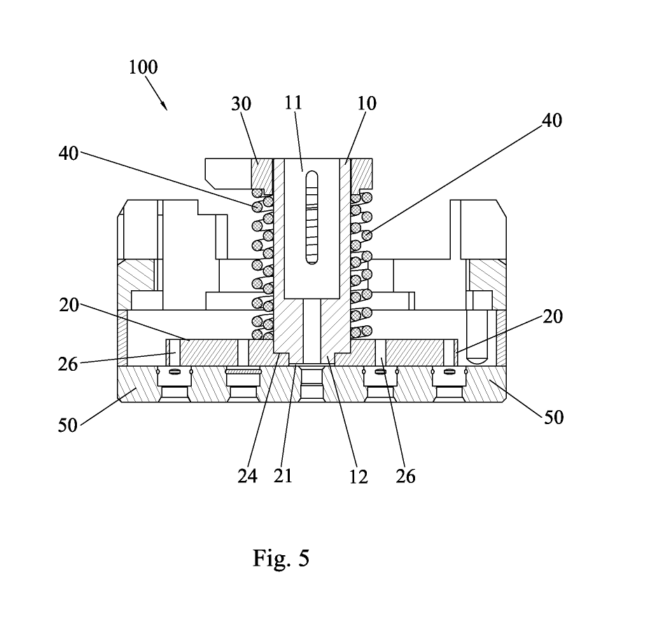

As another preferable embodiment, as shown in FIGS. 5, 7, 12 and 13, the nuclear core component hold-down assembly 100 of the present invention includes a spring guide 10, a base plate 20, a hold-down bar 30 and a spring element 40. The spring guide 10 is hollow, and an instrumentation insertion channel 11 is formed through the spring guide 10. The base plate 20 has a center hole 21 formed through a center thereof, and several water flow holes 22 formed around the center hole 21. The lower end of the spring guide 10 is connected and mated with the upper end of the base plate 20. Concretely, a first expanding slot 24 is extended in the center hole 21, and an insertion portion 12 is protruded from the lower end of the spring guide 10 and towards the base plate 20, and the instrumentation insertion channel is extended through the insertion portion. Further, the insertion portion 12 is inserted into the center hole 21 of the base plate 20 so as to connect and mate with it. The instrumentation insertion channel 11 is communicated with the center hole 21, and the base plate 20 is located above the adapter plate 50 and pressed against it directly. The hold-down bar 30 is slidably mounted on the upper end of the spring guide 10 and located above the base plate 20, and the spring element 40 is configured between the hold-down bar 30 and the base plate 20, by which the hold-down bar 300 moves downwards and pushes the base plate 20 to press against the adapter plate 50 directly. In such a way, the insertion portion 12 is engaged with the first expanding slot 24 accordingly, so that the connection between the spring guide 10 and the base plate 20 is more stable and firm, which ensures the base plate 20 can be pressed against the adapter plate 50 and, in turn achieves a safe and reliable hold-down.

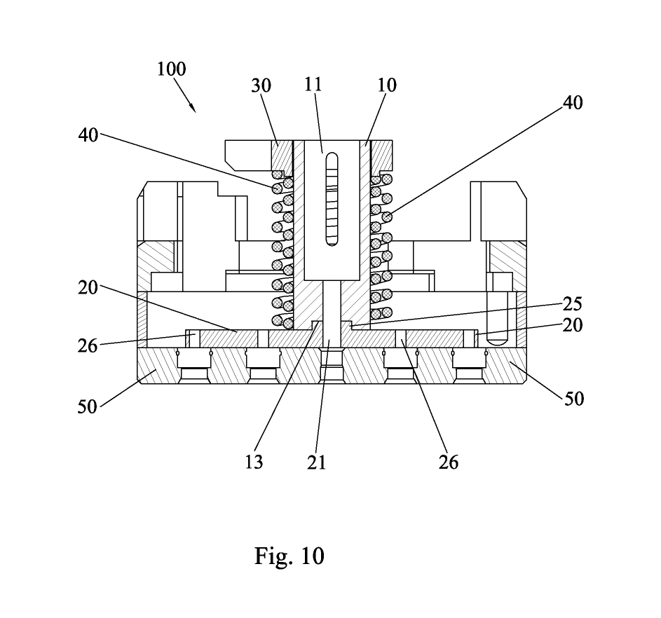

As another preferable embodiment, as shown in FIGS. 10-13, the nuclear core component hold-down assembly 100 of the present invention includes a spring guide 10, a base plate 20, a hold-down bar 30 and a spring element 40. The spring guide 10 is hollow, and an instrumentation insertion channel 11 is formed through the spring guide 10. The base plate 20 has a center hole 21 formed through a center thereof, and several water flow holes 22 formed around the center hole 21. The lower end of the spring guide 10 is connected and mated with the upper end of the base plate 20. Concretely, the lower end of the base plate 20 is provided with an upward protrusion 25 surrounding the center hole 21 and extending towards the spring guide 10, and the center hole 21 is extended through the upward protrusion 25 and connected with the lower end of the spring guide 10. The instrumentation insertion channel 11 is communicated with the center hole 21, and the base plate 20 is located above the adapter plate 50 and pressed against it directly. The hold-down bar 30 is slidably mounted around the upper end of the spring guide 10 and located above the base plate 20, and the spring element 40 is configured between the hold-down bar 30 and the base plate 20, by which the hold-down bar 30 moves downwards and pushes the downward protrusion 23 of the base plate 20 to contact and press against the adapter plate 50 directly.

As another preferable embodiment, as shown in FIGS. 10-13, the nuclear core component hold-down assembly 100 of the present invention includes a spring guide 10, a base plate 20, a hold-down bar 30 and a spring element 40. The spring guide 10 is hollow, and an instrumentation insertion channel 11 is formed through the spring guide 10. The base plate 20 has a center hole 21 formed through a center thereof, and several water flow holes 22 formed around the center hole 21. The lower end of the spring guide 10 is connected and mated with the upper end of the base plate 20. Concretely, the lower end of the base plate 20 is provided with an upward protrusion 25 surrounding the center hole 21 and extending towards the spring guide 10, the center hole 21 is extended through the upward protrusion 25, and the upward protrusion 25 is inserted into the spring guide 10 so that the base plate 20 is connected with the spring guide 10. The instrumentation insertion channel 11 is communicated with the center hole 21, and the base plate 20 is located above the adapter plate 50 and pressed against it directly. The hold-down bar 30 is slidably mounted around the upper end of the spring guide 10 and located above the base plate 20, and the spring element 40 is configured between the hold-down bar 30 and the base plate 20, by which the hold-down bar 30 moves downwards and pushes the downward protrusion 23 of the base plate 20 to contact and press against the adapter plate 50 directly. In such a way, the stable connection between the spring guide 10 and the base plate 20 is achieved by inserting the upward protrusion 25 into the spring guide 10.

As another preferable embodiment, as shown in FIGS. 10-13, the nuclear core component hold-down assembly 100 of the present invention includes a spring guide 10, a base plate 20, a hold-down bar 30 and a spring element 40. The spring guide 10 is hollow, and an instrumentation insertion channel 11 is formed through the spring guide 10. The base plate 20 has a center hole 21 formed through a center thereof, and several water flow holes 22 formed around the center hole 21. The lower end of the spring guide 10 is connected and mated with the upper end of the base plate 20. Concretely, the lower end of the base plate 20 is provided with an upward protrusion 25 surrounding the center hole 21 and extending towards the adapter plate 50, the center hole 21 is extended through the upward protrusion 25, and the upward protrusion 25 is inserted into the instrumentation insertion channel 11 in the spring guide 10 so that the upward protrusion 25 of base plate 20 is connected with the lower end of the spring guide 10. Further, the instrumentation insertion channel 11 is communicated with the center hole 21, and the base plate 20 is located above the adapter plate 50 and pressed against it directly. The hold-down bar 30 is slidably mounted around the upper end of the spring guide 10 and located above the base plate 20, and the spring element 40 is configured between the hold-down bar 30 and the base plate 20, by which the hold-down bar 30 moves downwards and pushes the downward protrusion 23 of the base plate 20 to contact and press against the adapter plate 50 directly. In such a way, since the instrumentation insertion channel 11 in the spring guide 10 is provided to allow the lower end of the spring guide 10 to insert and connect, such a structure is simple and practical, thus the stable and firm connection between the spring guide 10 and the base plate 20 is ensured.

As another preferable embodiment, as shown in FIGS. 10-13, the nuclear core component hold-down assembly 100 of the present invention includes a spring guide 10, a base plate 20, a hold-down bar 30 and a spring element 40. The spring guide 10 is hollow, and an instrumentation insertion channel 11 is formed through the spring guide 10. The base plate 20 has a center hole 21 formed through a center thereof, and several water flow holes 22 formed around the center hole 21. The lower end of the spring guide 10 is connected and mated with the upper end of the base plate 20. Concretely, the lower end of the base plate 20 is provided with an upward protrusion 25 surrounding the center hole 21 and extending towards the spring guide 10, and the center hole 21 is extended through the upward protrusion 25. Furthermore, a second expanding slot 13 is extended in the instrumentation insertion channel 11 in the lower end of the spring guide 10, and the upward protrusion 25 is inserted into the second expanding slot 13 to connect with it. The instrumentation insertion channel 11 is communicated with the center hole 21, and the base plate 20 is located above the adapter plate 50 and pressed against it directly. The hold-down bar 30 is slidably mounted around the upper end of the spring guide 10 and located above the base plate 20, and the spring element 40 is configured between the hold-down bar 30 and the base plate 20, by which the hold-down bar 30 moves downwards and pushes the downward protrusion 23 of the base plate 20 to contact and press against the adapter plate 50 directly. In such a way, since the upward protrusion 25 is engaged with the second expanding slot 13 accordingly, so that the connection between the spring guide 10 and the base plate 20 is more stable and firm, which ensures the base plate 20 can be pressed against the adapter plate 50 and, in turn achieves a safe and reliable hold-down.

As shown in FIGS. 4, 8 and 11, the center hole 21 of the base plate 20 is shaped as a frustum.

Preferably, as shown in FIGS. 12 and 13, the lower end of the base plate 20 is provided with multiple notches 27 depressed inwards, and multiple small holes 26 are formed through the notches 27 for inserting rods, such as thimble plug rods, primary neutron source rods, secondary neutron source rods, or burnable poison rods. Arrangement of the notches 27 improves the flowage of the coolant in the nuclear reactor, which improves the refrigeration effect of the coolant accordingly.

Preferably, as shown in FIGS. 3-11, the spring element 40 is a helical spring which is positioned around the spring guide 10. In such a way, it's helpful to position and restrict itself around the spring guide 10, and transfer stress to the base plate 20.

Preferably, as shown in FIGS. 3-13, edges of the base plate 20 are chamfered, which improves the flowage of the coolant in the nuclear reaction, and improves the refrigeration effect of the coolant accordingly.

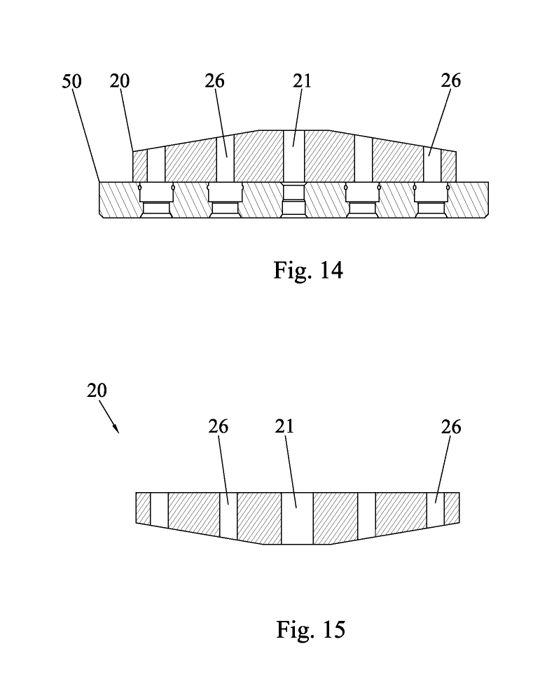

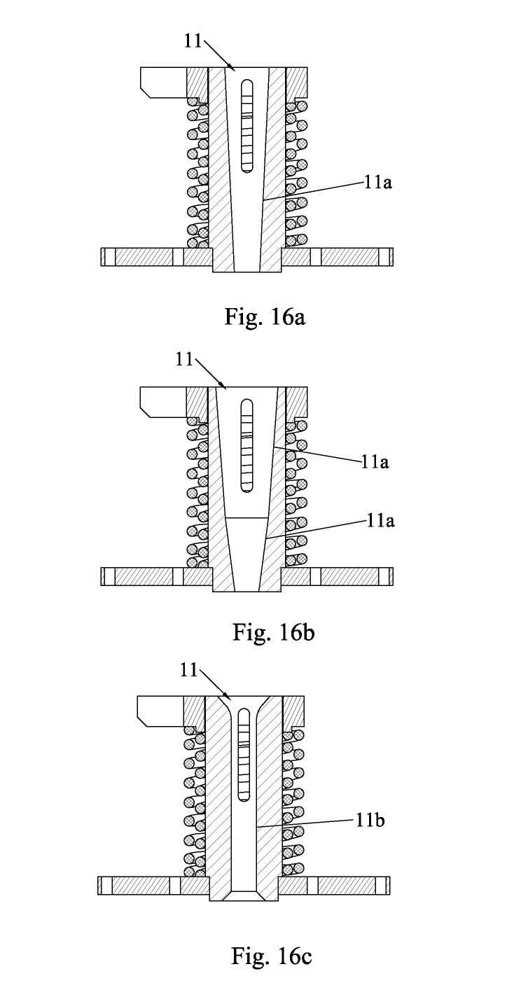

As a preferable embodiment, as shown in FIGS. 14-15, the base plate 20 has a frustum-shaped longitudinal section. Concretely, FIG. 14 shows the structure of the frustum-shaped base plate 20 and the adapter plate 50, as illustrated, the base plate 20 is a frustum structure which has a small top and a big bottom, and the top of the frustum structure is protruded towards the spring guide 10 for connecting with the lower end of the spring guide 10, the bottom of the frustum structure is flat to press against and hold down the adapter plate 50. As shown in FIG. 15, another frustum-shaped base plate 20 with a big top and a small bottom is illustrated. Concretely, the top of the frustum structure is flat for connecting with the lower end of the spring guide 10, and the bottom of the frustum structure is protruded towards the adapter plate 50, to press against and hold down the adapter plate 50. It should be noted that, the connecting way between the frustum-shape base plate 20 and the lower end of the spring guide 10 can be referred to means shown in FIGS. 3-11, but is not limited it.

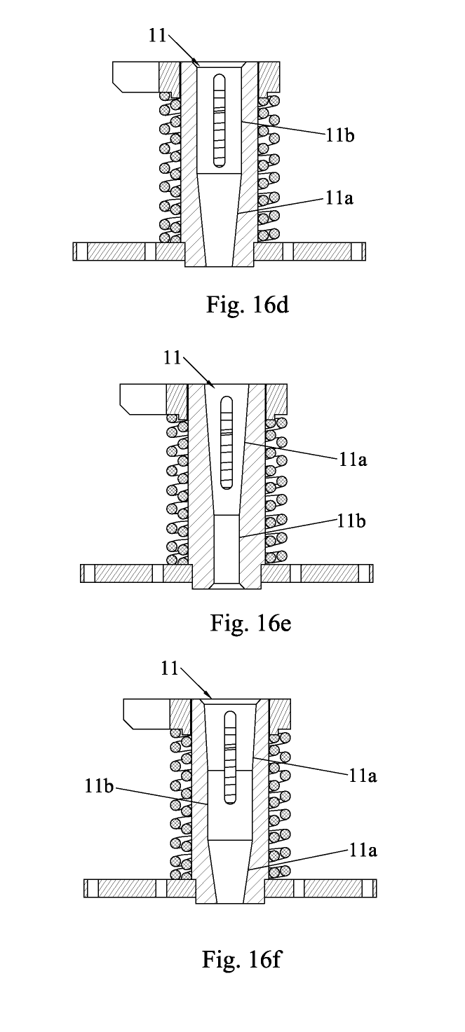

Preferably, the instrumentation insertion channel 11 includes at least one tapered channel with a wider upper portion and a narrow lower portion. Concretely, FIG. 16a shows a tapered channel 11a with a wider upper portion and a narrow lower portion; FIG. 16b shows two tapered channels 11a with a wider upper portion and a narrow lower portion, which are communicated with each other from up to down. Concretely, the upper tapered channel 11a is wider than the lower tapered channel 11a, and the bottom of the upper tapered channel 11a is communicated with the top of the lower tapered channel 11a. Due to the upper channel 11a is wider, so that the detector instrumentation can be guided in the spring guide 10; while the lower channel 11a is narrow, so that the detector instrumentation can be aligned with the instrumentation tube, which causes the detector instrumentation can be inserted into the instrumentation tube. Furthermore, since the taper channels 11a have a wider upper portion and a narrow lower portion, thus an inclined wall is formed, namely the inner wall of the spring guide 10 is shaped as a funnel, which is compatible to the detector instrumentation.

Preferably, as shown in FIG. 16c, the instrumentation insertion channel 11 includes at least one cylindrical channel 11b, which is convenient to guide the detector instrumentation. And the cylindrical channel 11b has fillet structure or chamfered structure at its upper portion or lower portion.

For example, concretely, as shown in FIG. 16d, the instrumentation insertion channel 11 includes a tapered channel 11a and a cylindrical channel 11b located above the tapered channel 11a; as shown in FIG. 16e, the instrumentation insertion channel 11 includes a tapered channel 11a and a cylindrical channel 11b located beneath the tapered channel 11a; as shown in FIG. 16f, the instrumentation insertion channel 11 includes two tapered channels 11a and a cylindrical channel 11b which is located between the two tapered channels 11a and is served as a transition zone therebetween.

Preferably, as shown in FIGS. 16a, 16b, 16d, 16e and 16f, each tapered channel 11a has a tapered angle in a range of 1° to 45°, so as to guide the detector instrumentation to the spring guide 10 swimmingly.

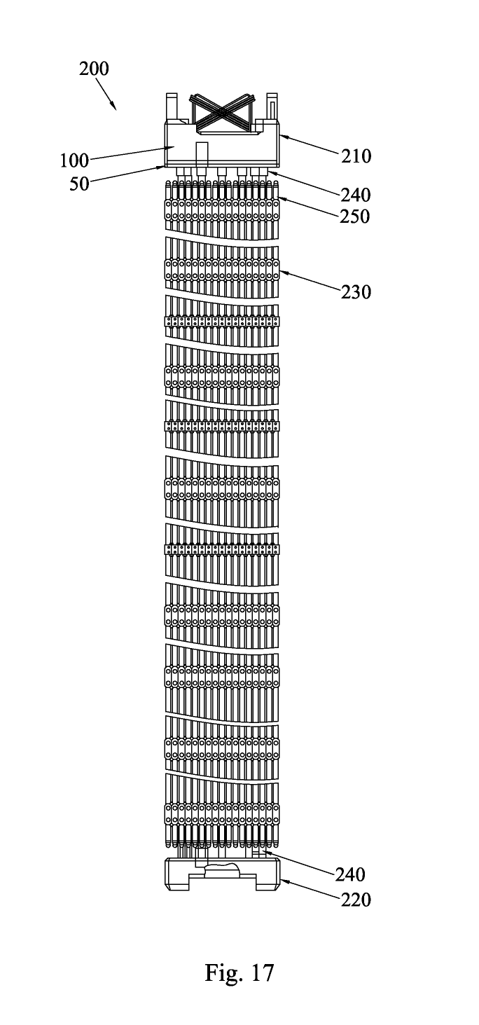

As shown in FIG. 17, nuclear reactor fuel assembly 200 of the present invention includes a bottom nozzle 210, a top nozzle 220, spacer grids 230, guide tubes 240 and fuel rods 250. Concretely, the fuel rods 250 and the guide tubes 240 are inserted into the spacer grids 230 respectively, and each of the guide tubes 240 has an upper end connected with the top nozzle 210 and a lower end connected with the bottom nozzle 220. More concretely, both the top nozzle 210 and the bottom nozzle 220 has an adapter plate 50 respectively, that is, the upper ends of the guide tubes 240 are connected with the adapter plate 50 of the top nozzle 210, and the lower ends of the guide tubes 240 are connected with the adapter plate (not labeled) of the bottom nozzle 220. Concrete structure, connection way and working principle of the components mentioned above are well known to the person skilled in the art, which are not described in detail. Concretely, the nuclear reactor fuel assembly 200 further includes a nuclear core component hold-down assembly 100 for holding down the adapter plate 20 of the top nozzle 210, and the nuclear core component hold-down assembly 100 is not limited to embodiments of FIGS. 3-11, and any nuclear reactor fuel assembly 200 with modification or equivalence based on the nuclear core component hold-down assembly 100 is within the protection scope of the present invention.

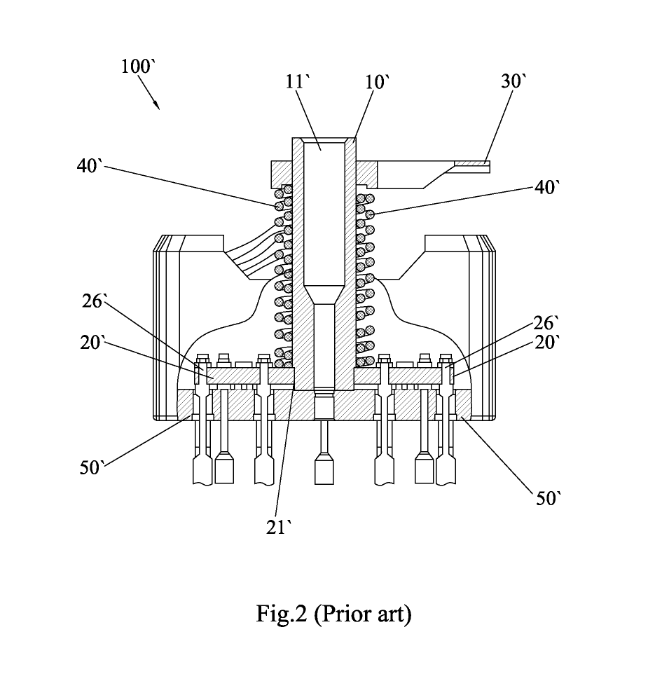

By combination with FIGS. 3-17, because the lower end of the spring guide 10 of the nuclear core component hold-down assembly 100 is connected with the adapter plate 50 directly and pressed against the base plate 20 located above, during working, the hold-down bar 30 is applied with force to move downwards and pushes the base plate 20 to contact and press against the adapter plate 50 due to the spring element 40, so as to hold down the adapter plate 50. Based on the adapter plate 50 is held down by the nuclear core component hold-down assembly 100 by means of the base plate 20, on one hand, the contacting area between the base plate 200 and the adapter plate 50 is increased, so that the stress endured by the base plate 20 and the adapter plate 50 becomes smaller and more even, which prevents the base plate 20 and the adapter plate 50 from being damaged; on the other hand, stress transfer among the components is like this, hold-down bar 30→spring element 40→base plate 20→adapter plate 50, which is drastically different from the conventional one (namely the stress transfer—hold-down bar→spring→base plate→spring guide→adapter plate, in FIG. 2). The present invention keeps the stress transfer in the vertical direction, so that problems brought by the stress transfer in the transverse direction could be avoided, therefore the nuclear core component hold-down assembly 100 of the present invention has simple structure with reasonable arrangements, and high stabilization and reliability, and breaks through the conventional stress transfer in the nuclear core component hold-down assembly to achieve the new concept and new technique.

It should be noted that, in nuclear reactor field, security and reliability of every component are much rigorous than other common industrial fields, thus it's necessary for every component used in the nuclear reactor to undergo strict detection and testing for security and reliability. In view of this strict requirement, after long-term research and practice, the inventors of the present invention found the three big drawbacks in the conventional nuclear core component hold-down assembly disclosed in CN101587755A, basing on which the nuclear core component hold-down assembly of the present invention is invented. In comparison with the conventional one, although modification of the structure is not very tremendous, the stress transfer and working principle caused by the modification are distinct from the prior art. Such modification brings positive beneficial effects and breaks through the conventional thought, and achieves the nuclear core component hold-down assembly with new concept and new technique, which provides effective protection for utilizing safe and reliable nuclear energy.

In addition, structures and working principles of the top nozzle 210, the bottom nozzle 220, the spacer grids 230, the guide tubes 240, the fuel rods 250, the adapter plate 50, and the instrumentation insertion channel 11, the center hole 21, and the water flow hole 22 are well known to persons skilled in the art, which are not described in detail here.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A nuclear core component hold-down assembly, configured on an adapter plate of a top nozzle, the nuclear core component hold-down assembly comprising:
a hollow spring guide in which an instrumentation insertion channel is formed;
a base plate which has a center hole formed through a center thereof, and several water flow holes formed around the center hole; a lower end of the spring guide connecting and mating with an upper end of the base plate, the instrumentation insertion channel communicating with the center hole, and the base plate locating above the adapter plate and pressing against it directly;
a hold-down bar slidably mounted on an upper end of the spring guide and locating above the base plate; and
a spring element configured between the hold-down bar and the base plate, by which the hold-down bar pushes the base plate to cause the base plate to press against the adapter plate.

2. The nuclear core component hold-down assembly according to claim 1, wherein a lower end of the base plate is provided with a downward protrusion surrounding the center hole and extending towards the adapter plate, and the center hole is extended through the downward protrusion, by which the base plate is pressing against the adapter plate directly.

3. The nuclear core component hold-down assembly according to claim 1, wherein the lower end of the spring guide is inserted into the base plate so as to connect and mate with it.

4. The nuclear core component hold-down assembly according to claim 3, wherein the lower end of the spring guide is inserted into the center hole of the base plate so as to connect and mate with it.

5. The nuclear core component hold-down assembly according to claim 1, wherein a first expanding slot is extended in the center hole, and the lower end of the spring guide is inserted into the first expanding slot so as to connect and mate with the base plate.

6. The nuclear core component hold-down assembly according to claim 5, wherein an insertion portion is protruded from the lower end of the spring guide and towards the base plate, the instrumentation insertion channel is extended through the insertion portion, and the insertion portion is inserted into the center hole of the base plate so as to connect and mate with it.

7. The nuclear core component hold-down assembly according to claim 1, wherein the center hole of the base plate is shaped as a frustum.

8. The nuclear core component hold-down assembly according to claim 1, wherein a lower end of the base plate is provided with an upward protrusion surrounding the center hole and extending towards the spring guide, and the center hole is extended through the upward protrusion, by which the base plate connects and mates with the lower end of the spring guide.

9. The nuclear core component hold-down assembly according to claim 8, wherein the upward protrusion is inserted into the spring guide so that the base plate is connected and mated with the spring guide.

10. The nuclear core component hold-down assembly according to claim 8, wherein a second expanding slot is extended in the instrumentation insertion channel of the lower end of the spring guide, and the upward protrusion is inserted into the second expanding slot so as to connect and mate with it.

11. The nuclear core component hold-down assembly according to claim 1, wherein the base plate has a frustum-shaped longitudinal section.

12. The nuclear core component hold-down assembly according to claim 1, wherein multiple notches are depressed inwards on a lower end of the base plate, and multiple small holes are formed through the notches.

13. The nuclear core component hold-down assembly according to claim 1, wherein the spring element is a helical spring which is positioned around the spring guide.

14. The nuclear core component hold-down assembly according to claim 1, wherein edges of the base plate are chamfered.

15. The nuclear core component hold-down assembly according to claim 1, wherein the instrumentation insertion channel includes at least one tapered channel with a wider upper portion and a narrow lower portion.

16. The nuclear core component hold-down assembly according to claim 15, wherein the tapered channel has a tapered angle in a range of 1° to 45°.

17. The nuclear core component hold-down assembly according to claim 1, wherein the instrumentation insertion channel includes at least one cylindrical channel.

18. A nuclear reactor fuel assembly, comprising a bottom nozzle, a top nozzle, spacer grids, guide tubes and fuel rods, the fuel rods and the guide tubes inserted into the spacer grids respectively, the spacer grids having upper ends connected and mating with the top nozzle and lower ends connected and mating with the bottom nozzle, and the nuclear reactor fuel assembly further comprising a nuclear core component hold-down assembly according to claim 1 which is arranged for holding down an adapter plate of the top nozzle.
